(19) United States
(12) Patent Application Publication
(10) Pub. No.: US 2021/0078697 A1
(43) Pub. Date: Mar. 18, 2021

(54) SHOCK ABSORBING FOOT PIECE FOR SMALL APPARATUS

(71) Applicant: Shake N Bake LLC, Vermilion, OH (US)

(72) Inventors: Philip Klassen, Aberdeen, ID (US); Eric Wayne Jackson, Rockford, MN (US)

(21) Appl. No.: 17/019,323

(22) Filed: Sep. 13, 2020

Related U.S. Application Data
(60) Provisional application No. 62/900,326, filed on Sep. 13, 2019.

(51) Int. Cl. B64C 25/62; F16F 1/06; F16F 15/04; F16F 1/12; A47B 91/04; F16M 7/00; B64C 39/02

(52) U.S. Cl. CPC B64C 25/62; F16F 1/06; F16F 15/04; F16F 1/12; A47B 91/04; B64C 2201/027; B64C 39/024; F16F 2226/04; F16F 2224/02; F16M 2200/08; F16M 7/00

(57) ABSTRACT

Disclosed herein are shock absorbing foot pieces configured to be attached to an apparatus and to absorb the weight of the attached apparatus and any impact caused by the normal usage of the apparatus. In one or more embodiments, the shock absorbing foot pieces comprise multiple elements including a biasing spring and that are configured as a unitary piece.

### TECHNICAL FIELD

The present disclosure relates to shock absorbing pieces attached to apparatus such as UAVs. In particular, in one or more embodiments, the present disclosure relates to shock absorbing foot pieces for attachment to UAV landing gear.

### BACKGROUND

Various devices and appliances exist that, when utilized, impact the ground through one or more axial or longitudinal elements. Some relatively “low-tech” examples include canes and/or walking assistance devices that impact the ground via one or more longitudinal members, as well as appliances and equipment which are seated on the ground via one or more longitudinal members (e.g., legs). On the other hand, in some exemplary “high-tech” examples, unmanned mobile devices exist that utilize some form of impact elements to contact the ground. For example, various robotic walkers exist, such as bipedal and multi-pedal walkers (e.g., spider robots), that utilize longitudinal impact elements, such as leg members. As another example, various unmanned aerial vehicles (UAVs) exist that utilize longitudinal members (e.g., legs, extenders) for standing on a ground surface and for landing.

In one aspect, as the use of such high-tech devices increases, the complexity and cost of such devices increases as well—not only with regard to the devices themselves, but also including the payloads (e.g., cameras, sensors, etc.) carried by such devices. It is desirable for such devices to be able to impact the ground without unduly absorbing (either by the device itself or the associated payloads) the impact forces associated with the use of such devices. For example, it is desirable for UAVs to land without unduly absorbing impact forces associated with landing. Additionally, even for relatively low tech devices, the lessening of impact forces can be desirable in certain applications.

### BRIEF DESCRIPTION OF THE DRAWINGS

The present disclosure, in accordance with one or more various embodiments, is described in detail with reference to the following drawings. The drawings are provided for purpose of illustration only and merely depict aspects of typical or example embodiments. These drawings are provided to facilitate the reader's understanding of the disclosure and shall not be considered limiting of the breadth, scope, or applicability of the disclosure.

The components in the drawing are not necessarily drawn to scale. In the drawings, like reference numerals designate corresponding parts throughout the several views. One of ordinary skill in the art will appreciate that a component may be designed as multiple components or that multiple components may be designed as a single component.

FIG. 1A shows an elevational longitudinal cross-section of a footer described herein.

FIG. 1B shows a perspective longitudinal cross-section of a foot piece described herein.

FIG. 1C shows a perspective horizontal cross-section of a foot piece described herein.

FIG. 1D shows a perspective horizontal cross-section of a foot piece described herein, wherein the cross-section is closer to the base of the foot piece than in FIG. 1C.

FIG. 1E shows a perspective view of a foot piece described herein viewed from the top of the foot piece.

FIG. 1F shows a perspective view of a foot piece described herein viewed from the bottom of the foot piece.

FIG. 1G shows a perspective view of a foot piece described herein.

FIG. 2 shows an elevational view of a UAV fitted with foot pieces described herein.

### DETAILED DESCRIPTION

The novel apparatus of the embodiments described herein allow users to operate certain apparatus, including UAVs (e.g., drones) in a manner that lessens the force of impact with the ground on these apparatuses. In particular, in one or more embodiments described herein, the footers of the present disclosure are configured to attach to landing armatures (e.g., legs) attached to UAVs (e.g., drones) to lessen the impact of landing on the UAVs. In one or more embodiments, the apparatus comprises a boot/footer configured as a unitary/single piece items having a compression spring included in a cover.

It should be understood that aspects, features or functions that are described in relation to an embodiment are not necessarily limited to the embodiment described, but rather may be applicable to one or more embodiments, unless expressly described otherwise. Also, the description set forth herein is not to be construed as limited to the embodiments shown. Rather, it is appreciated that various modifications may occur to those skilled in the art that, while not specifically set forth herein, are nevertheless within the spirit and scope of the description. When an embodiment is described as “exemplary” (or similarly) herein, it is to be understood as one non-limiting example embodiment, and does not preclude other embodiments that may not include the limitations described in the exemplary embodiment

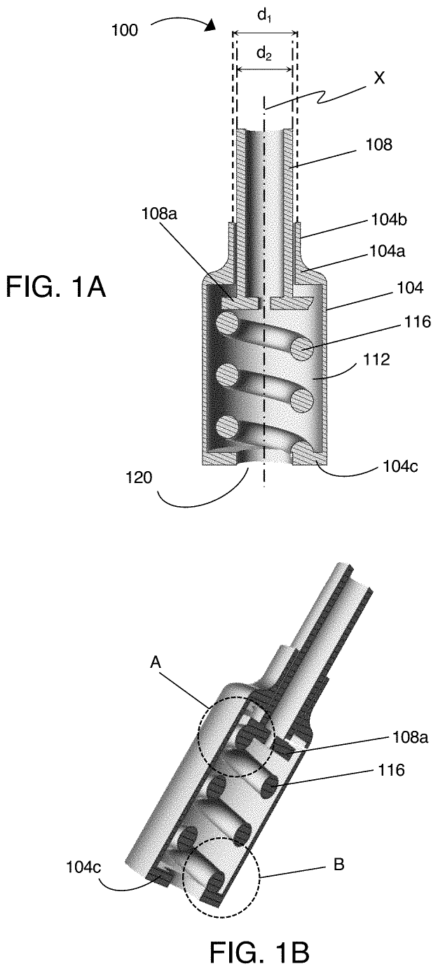

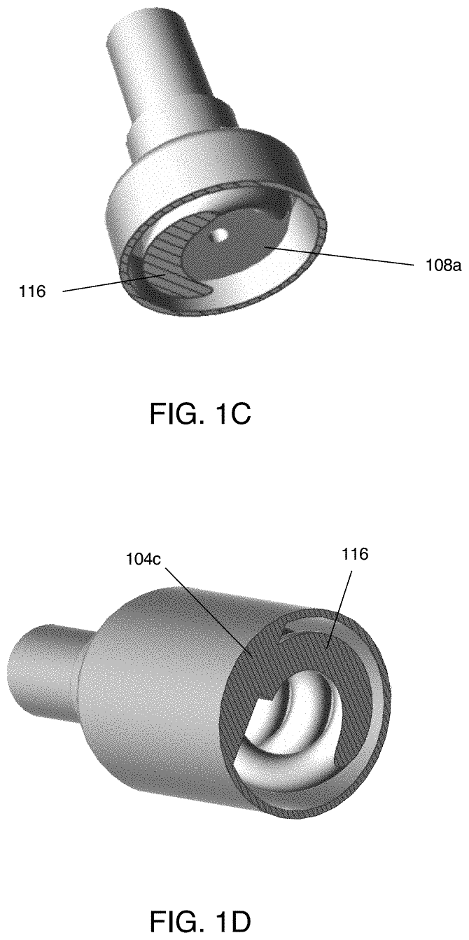

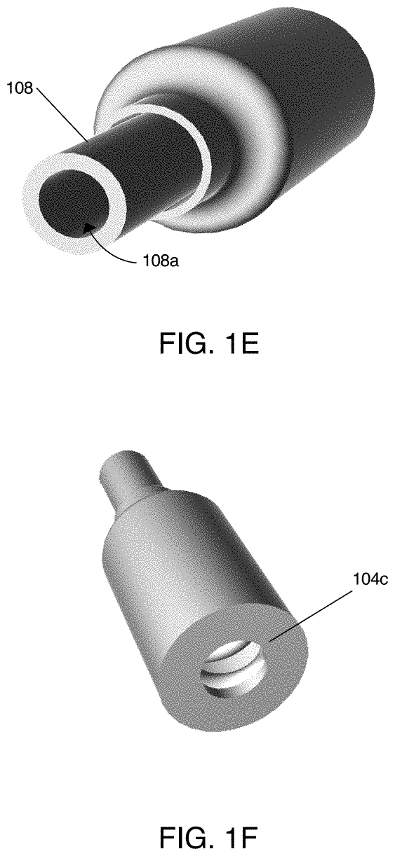

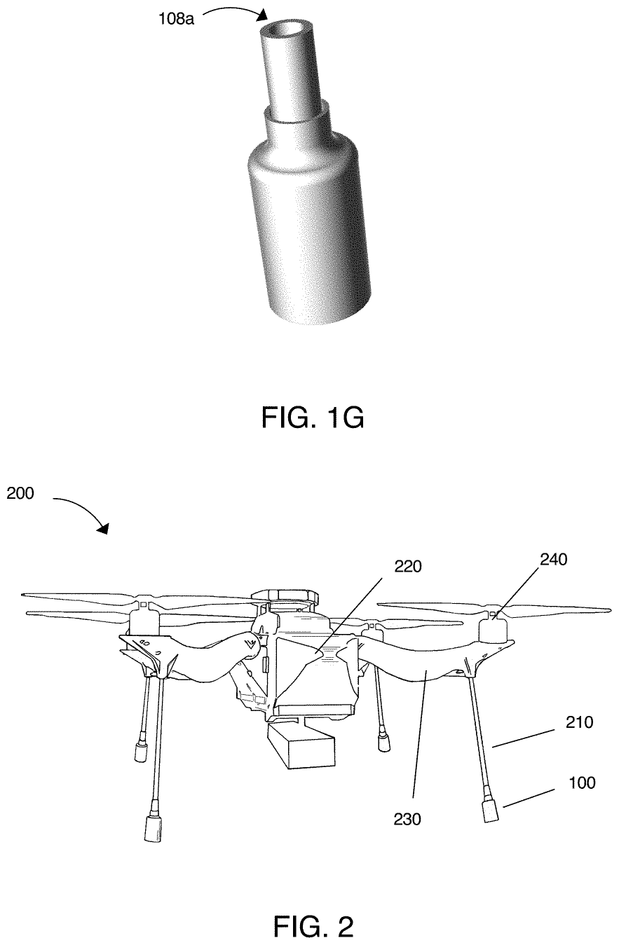

With reference to FIG. 1A, a shock absorbing boot/foot piece 100 of the present disclosure is shown. Foot 100 comprises a capped cylindrical member 104 and a plunging rod 108 slidably received inside cylindrical member 104, coaxially about its longitudinal axis X. At its near end or first end (the upper end, with reference to FIG. 1A), cylindrical member 104 is partially capped in a manner that allows for a through-hole to receive plunging rod 108 and a collar to restrain and guide it. For example, in one or more exemplary embodiments, the wall of cylindrical member 104 extends in an approximately orthogonal direction, inwardly toward longitudinal axis X, thereby forming an upper flange portion 104a. In one or more embodiments, the wall of cylindrical member 104 further extends upwardly (with reference to FIG. 1A) in an approximately orthogonal direction in relation to the upper flange portion 104a, forming a cylindrical collar portion 104b that acts as a retaining collar member limiting cross-axial movement for plunging rod 108. As may be readily appreciated, the diameter d₁ of cylindrical collar portion 104b is smaller than the diameter of cylindrical member 104.

With continuing reference to FIG. 1A, the wall of capped cylindrical member 104 may generally enclose and form central chamber 112. In addition, plunging rod 108 may generally comprise a cylindrical member having an outer diameter, d₂, that is smaller than the inner diameter, d₁, of cylindrical collar portion 104b and has a plunging rod flange 108a at its distal end (the lower end, with reference to FIG. 1A). Plunging rod flange 108a comprises a flange that is generally orthogonal to plunging rod 108 and is seated in chamber 112 below upper flange portion 104a of cylindrical member 104. It may be appreciated that the plunging rod flange 108a is dimensioned such that the upward movement (with reference to FIG. 1A) of plunging rod 108 along longitudinal axis X is limited by upper flange portion 104a by causing an abutment between upper flange portion 104a and plunging rod flange 108a when plunging rod 108 is caused to be moved upward in the axial direction to its fullest extent.

Continuing still with reference to FIG. 1A, shock absorbing foot piece 100 of the present disclosure also comprises a compression spring 116 housed in central chamber 112 and configured to apply an upward biasing force (with reference to FIG. 1A) to the plunging rod flange 108a along the longitudinal axis X. In one or more embodiments, compression spring 116 is configured (e.g., sized) such that the plunging rod flange 108a is proximate to and/or abuts upper flange portion 104a when the device is not acted upon by outside forces (e.g., in a normal state).

In one or more embodiments, cylindrical member 104 is capped (fully or partially) at its distal end (lower end, with reference to FIG. 1A). For example, in one or more exemplary embodiments, the wall of cylindrical member 104 extends at the distal end in an approximately orthogonal direction, inwardly toward longitudinal axis X, thereby forming a distal flange portion 104c. In one or more embodiments, lower flange 104c does not completely cap the distal end, but instead forms a distal throughhole 120 that permits, e.g., air egress to/from cylindrical chamber 104 when spring 116 is compressed and decompressed.

Referring to FIGS. 1B-1D, in one or more exemplary embodiments disclosed herein, the shock absorbing foot is a unitary piece. In such preferred embodiments, spring 116 is integrally attached at its near end (the upper end, with reference to FIG. 1B) to plunging rod flange 108a, and at its distal end (the lower end, with reference to FIG. 1B) to lower flange 104c. The exemplary integral attachment of the upper and lower ends in the areas marked “A” and “B” in FIG. 1B are illustrated in greater detail in FIGS. 1C and 1D, respectively.

With reference to FIG. 1C, shown is a sectional perspective view of shock absorbing foot 100, having a unitary construction, sectioned by a plane approximately orthogonal to the X axis near the upper/near end of shock absorbing foot 100, in the area marked “A” in FIG. 1B. As may be seen, the upper end of spring 116 is integrally formed with plunging rod flange 108a, such that it is a single, unitary piece. Note that plunging rod flange 108a itself is shaped as a flat disk integrally formed with plunging rod 108.

With reference to FIG. 1D, shown is a sectional perspective view of shock absorbing foot 100, having a unitary construction, sectioned by a plane approximately orthogonal to the X axis near the lower/distal end of shock absorbing foot 100, in the area marked “B” in FIG. 1B. As may be seen, the distal end of spring 116 is integrally formed with lower flange 104c, such that it is a single, unitary piece. Note that lower flange 104c itself is shaped as a flat disk (see FIG. 1F) integrally formed with the wall of cylindrical member 104.

In one or more non-limiting embodiments, shock absorbing foot 100 is 3D printed as a single, unitary piece using a suitable plastic resin, such as, e.g., a nylon resin.

With reference to FIGS. 1E & 1F, it may be seen that plunging rod 108 may be formed as a hollow cylindrical member having an interior open space 108a along its axis. In one or more embodiments, open space 108a is configured to receive a corresponding attached member. The attached member depends on the end-use application, and in one or more embodiments may be a UAV leg member, such as leg member 210 shown in FIG. 2 and described more fully below. Accordingly, the distal end of leg member 210 is configured to snugly fit into open space 108a, but in other embodiments may be attached by any suitable means. As may be appreciated, the attachment means between shock absorbing foot 100 and the corresponding attached member (e.g., UAV leg member, walking cane shaft, appliance footer leg member, etc.) may be any suitable mechanical means capable of providing the desired functionality.

With reference to FIG. 2, an exemplary UAV 200 is shown, having four shock absorbing feet 100 attached at the distal ends of four leg members 210. In one or more embodiments, UAV 200 may comprise a body portion 220 and a plurality of armatures 230. Each armature 230 may have a first end attached to body portion 220 and a second end opposite the first end for, e.g., mounting motors/rotors 240. Leg members 210 may generally be any longitudinal members dimensioned in such a manner and comprised of such material so as to serve as a suitable landing gear for UAV 200. For example, in one or more embodiments, leg members 210 are comprised of a nylon resin material and are dimensioned to be from about 4″ to about 24″ in length; in other embodiments, from about 6″ to about 16″ in length.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure. We therefore claim as our invention all that comes within the scope of these claims.

We claim:

1. A shock absorbing foot piece comprising:
a hollow cylindrical body member extending along a longitudinal axis having a top end and a bottom end and enclosing a body member interior space;
a top cap element having an outer portion and an inner portion opposite the outer portion, wherein the outer portion is affixed to the top end of the cylindrical body member along the circumference of the cylindrical body member and wherein the top cap extends inwardly from the outer portion to the inner portion and toward the longitudinal axis a distance that is less than the radius of the cylindrical body member, forming a top throughhole;
a bottom cap element having an outer portion and an inner portion opposite the outer portion, wherein the outer portion is affixed to the bottom end of the cylindrical body member along the circumference of the cylindrical body member and wherein the bottom cap extends inwardly from the outer portion to the inner portion and toward the longitudinal axis a distance that is less than the radius of the cylindrical body member, forming a bottom throughhole;
a biasing spring element located in the body member interior space having a top end and a bottom end;
a cylindrical plunging rod having a top end and a bottom end and extending through the top throughhole along the longitudinal axis;
and a plunging rod flange affixed to the bottom end of the cylindrical plunging rod and extending approximately orthogonally to the longitudinal axis, wherein the plunging rod flange is dimensioned so as to have a larger diameter than the top throughhole,
wherein the plunging rod flange is located between the top cap element and the bottom cap element,
wherein the bottom end of the biasing spring element is seated against the bottom cap element and the top end of the biasing spring element is seated against the plunging rod flange,
wherein the biasing spring element is normally biased so as to cause the plunging rod flange to abut the top cap element with a biasing force, and
wherein the top end of the cylindrical plunging rod comprises an attachment element for attaching the shock absorbing foot piece to an apparatus.

2. The shock absorbing foot piece of claim 1, further comprising a cylindrical collar element having a top end and a bottom end opposite the top end, wherein the bottom end of the cylindrical collar element is affixed to the top cap element along the circumference of the top throughhole.

3. The shock absorbing foot piece of claim 1, wherein the top end of the biasing spring element is affixed to the plunging rod flange and the bottom end of the biasing spring element is affixed to the bottom cap.

4. The shock absorbing foot piece of claim 2, wherein all the elements are configured as a unitary piece.

5. The shock absorbing foot piece of claim 3, wherein the biasing spring element is configured so as to be capable of absorbing the weight of an attached apparatus and the force of any impact with the ground caused by the normal usage of the apparatus by a user.

6. The shock absorbing foot piece of claim 4, wherein the shock absorbing foot piece is manufactured by an additive manufacturing process.

7. The shock absorbing foot piece of claim 5, wherein the shock absorbing foot piece is manufactured by an additive manufacturing process.

8. The shock absorbing foot piece of claim 5, wherein the attached apparatus is a UAV.

9. A UAV having a UAV body, a plurality of armatures, each having a first end attached to the UAV body and a second end opposite the first end, a plurality of leg members, each having a first end attached to an armature and a second end opposite the first end, and a plurality of shock absorbing foot pieces, each foot piece attached to the second end of a leg member, wherein each shock absorbing foot piece comprises:
a hollow cylindrical body member extending along a longitudinal axis having a top end and a bottom end and enclosing a body member interior space;
a top cap element having an outer portion and an inner portion opposite the outer portion, wherein the outer portion is affixed to the top end of the cylindrical body member along the circumference of the cylindrical body member and wherein the top cap extends inwardly from the outer portion to the inner portion and toward the longitudinal axis a distance that is less than the radius of the cylindrical body member, forming a top throughhole;
a bottom cap element having an outer portion and an inner portion opposite the outer portion, wherein the outer portion is affixed to the bottom end of the cylindrical body member along the circumference of the cylindrical body member and wherein the bottom cap extends inwardly from the outer portion to the inner portion and toward the longitudinal axis a distance that is less than the radius of the cylindrical body member, forming a bottom throughhole;
a biasing spring element located in the body member interior space having a top end and a bottom end;
a cylindrical plunging rod having a top end and a bottom end and extending through the top throughhole along the longitudinal axis;
and a plunging rod flange affixed to the bottom end of the cylindrical plunging rod and extending approximately orthogonally to the longitudinal axis, wherein the plunging rod flange is dimensioned so as to have a larger diameter than the top throughhole,
wherein the plunging rod flange is located between the top cap element and the bottom cap element,
wherein the bottom end of the biasing spring element is seated against the bottom cap element and the top end of the biasing spring element is seated against the plunging rod flange, wherein the biasing spring element is normally biased so as to cause the plunging rod flange to abut the top cap element with a biasing force, and
wherein the top end of the cylindrical plunging rod comprises an attachment element for attaching the shock absorbing foot piece to the leg member.

10. The UAV of claim 9, further comprising a cylindrical collar element having a top end and a bottom end opposite the top end, wherein the bottom end of the cylindrical collar element is affixed to the top cap element along the circumference of the top throughhole.

11. The UAV of claim 9, wherein the top end of the biasing spring element is affixed to the plunging rod flange and the bottom end of the biasing spring element is affixed to the bottom cap.

12. The UAV of claim 10, wherein all the elements are configured as a unitary piece.

13. The UAV of claim 12, wherein the biasing spring element is configured so as to be capable of absorbing the weight of the UAV and the force of any impact with the ground caused by the normal usage of the UAV by a user.

14. The UAV of claim 12, wherein the shock absorbing foot piece is manufactured by an additive manufacturing process.

15. The UAV of claim 13, wherein the shock absorbing foot piece is manufactured by an additive manufacturing process.

16. The UAV of claim 15, wherein the shock absorbing foot pieces are each comprised of a nylon resin material and are dimensioned to be from about 4″ to about 24″ in length.
